(19) United States
(12) Patent Application Publication
(10) Pub. No.: US 2024/0043047 A1
(43) Pub. Date: Feb. 8, 2024

(54) RAIL VEHICLE CAR HAVING A TANK

(71) Applicant: Siemens Mobility GmbH, München (DE)

(72) Inventors: Markus Wilhelm, Mönchengladbach (DE); Jonas Ruckes, Erlangen (DE); Andreas Winzen, Nürnberg (DE); Meike Meller, Nürnberg (DE); Helmut Treutler, Krefeld (DE); Roger Gansekow, Kempen (DE); Johannes Hartl, Moers (DE); De-Niang Maria Peymandar, Mönchengladbach (DE)

(21) Appl. No.: 18/258,868

(22) PCT Filed: Nov. 23, 2021
(86) PCT No.: PCT/EP2021/082649

§ 371 Date: Jun. 22, 2023

(30) Foreign Application Priority Data
Dec. 22, 2020 (DE) 10 2020 216 497.5

(51) Int. Cl. B61D 5/06

(52) U.S. Cl. CPC B61D 5/06

(57) ABSTRACT

A rail vehicle car includes at least one tank for storing gaseous fuels. The at least one tank is integrated into a car body shell of the rail vehicle, and the walls of the tank are constructed in such a way that they assume a load-bearing function within the car body shell.

The invention relates to a rail vehicle car with at least one tank for storing gaseous fuels such as hydrogen/hydrogen compounds as fuel for a fuel cell or liquefied petroleum gas (LPG) or compressed natural gas (CNG).

In particular, electric trainsets currently obtain their energy predominantly from a catenary. However, there are various railway lines both in Germany and worldwide which are not electrified and therefore cannot be used by an electric trainset which draws its energy purely from the catenary. Trains with a diesel drive have been used up to now on lines of this type.

Increasingly, however there are more and more alternative drive concepts or solutions for providing the trainset with electric energy for catenary-free lines. These are mainly battery stores and fuel cells. Fuel cells use hydrogen to generate electric energy which is in turn used for the drive and the auxiliary systems of the trainset. Further possible fuels are LPG or CNG.

To this extent, a trainset which can be operated using hydrogen comprises at least one rail vehicle car which is equipped with a hydrogen tank for storing the hydrogen. These hydrogen tanks typically consist of wound carbon fiber vessels with PE lines. This material has a different thermal expansion, however, than the wagon car, typically manufactured from aluminum or steel, of the rail vehicle. As a result, complex structures are required for fastening a hydrogen tank securely on the rail vehicle car, but permitting the different thermal expansion. This results in a high weight (axle load) of the trainset and leads to doubling of the material usage at some locations. In addition to the length change of the material on account of thermal expansion, a significant expansion of the hydrogen tank in its longitudinal direction and a small radial expansion also occur on account of the hydrogen tank being filled with compressed hydrogen.

The usability of the known hydrogen tanks additionally cannot be extended as required on account of the necessary space requirement for other components. The hydrogen tank and other components of the trainset are typically mounted on the roof of the latter, with the result that any desired amount of space is not available for dimensioning of the hydrogen tank. This in turn limits the range of the trainset on catenary-free lines.

Proceeding herefrom, the invention is based on the object of developing a rail vehicle car of the type mentioned at the outset in such a way that both different thermal expansions of used materials are reduced and a capacity of the tank is increased.

This object is achieved by way of a rail vehicle car as claimed in claim 1, in accordance with which the at least one tank is integrated into a car body shell of the rail vehicle, and the walls of the tank are designed in such a way that they assume a load-bearing function within the car body shell.

The tank is designed to store gaseous fuels, for example hydrogen, hydrogen compounds, LPG or CNG. Closed hollow chambers, for example aluminum extruded profiles or steel box structures, are often provided in structures of car body shells. These hollow chambers can be used according to the invention as pressure tanks for hydrogen.

It can therefore be provided, for example, that the tank is produced from the same material, for example steel or aluminum, as the car body shell. This avoids negative effects of different thermal expansions. As an alternative, however, it would also be possible that the tank is manufactured from other materials suitable for storing gaseous fuels, for example GFRP or CFRP. In addition, the car body shell which is typically composed of end walls, side walls, roof and chassis provides a very great volume for storing hydrogen. Here, the tank will have to be arranged in regions of the car body shell which are loaded by comparatively statically small loads, in particular away from bogies, in the region of which the car body shell is typically reinforced. This is the case regardless of whether the car body shell is manufactured in an integral or differential design. The hydrogen tank can be connected with the aid of suitable joining methods to adjoining regions of the car body shell of the rail vehicle car, for example by way of welding or structural adhesive bonding.

A longitudinal portion of the car body shell is preferably formed over the entire cross section of walls (side walls, roof, chassis) of the car body shell at least predominantly or else completely by the tank. In this embodiment, said longitudinal portion is joined by the car body shell which is manufactured in a conventional design, the longitudinal portion which forms the tank having the same static properties as a conventionally produced longitudinal portion, used at the same location, of a car body shell. In this embodiment, different thermal expansions between the tank material and the adjoining car body shell material are comparatively non-critical.

In one preferred embodiment, the longitudinal portion which forms the tank can completely enclose an end wall or else intermediate wall, running in the transverse direction of the rail vehicle car, of the car body shell. Just one end wall of the car body shell already provides a very comprehensive volume for storing hydrogen.

In the case where the rail vehicle car is equipped with end-side bogies, the longitudinal portion which forms the tank can comprise an overhang, lying outside the bogie regions, of the car body shell. In addition, it is possible that an overhang of this type and an adjoining end wall are together incorporated completely into the configuration of the tank. The same arrangement of tanks is also advantageous in the case of rail vehicle cars with single bogies which are arranged centrally in the longitudinal direction thereof.

The longitudinal portion which forms the tank can advantageously be arranged centrally outside the bogie regions and over a length of the car body shell. This is favorable, in particular, in the case of rail vehicle cars which are part of a trainset, in the case of which the cars either in each case have end-side bogies or are coupled to one another via, for example, what are known as “Jacobs bogies” in the form of an articulated train.

In a further preferred embodiment, the rail vehicle car can be configured as a bogie-less car transition module, in the case of which longitudinal forces between car bodies adjoining the ends of the car transition module are transmitted without involvement of the car body shell of the car transition module exclusively via a coupling rod of the car transition module. In this case, the car body shell can be configured and used at least predominantly or else completely as a tank. This is based on the fact that the car body shell of the car transition module is not involved in the longitudinal force transmission within a trainset which comprises this car transition module, and therefore has to fulfill only small static requirements.

Exemplary embodiments of the invention will be explained in greater detail in the following text with reference to the drawings, in which:

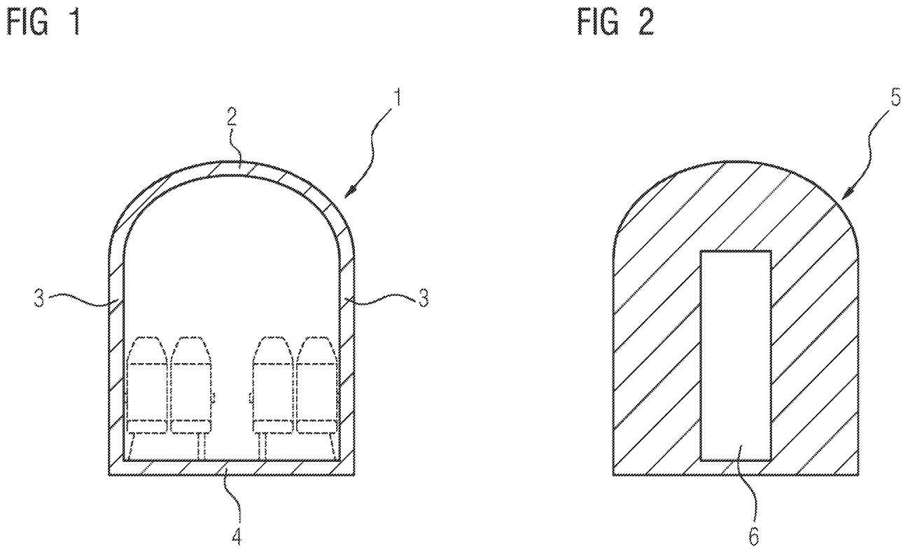

FIG. 1 shows a cross-sectional view of a longitudinal portion, configured as a hydrogen tank, of a car body shell for a rail vehicle in a first embodiment,

FIG. 2 shows a cross-sectional view of a longitudinal portion, configured as a hydrogen tank, of a car body shell for a rail vehicle in a second embodiment,

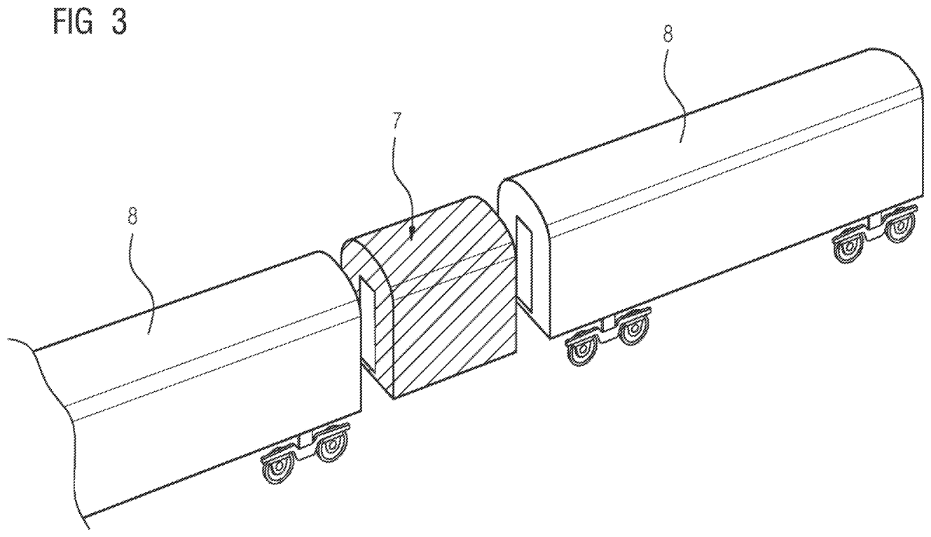

FIG. 3 shows a perspective view of a car transition module, used as a hydrogen tank, with adjoining support cars,

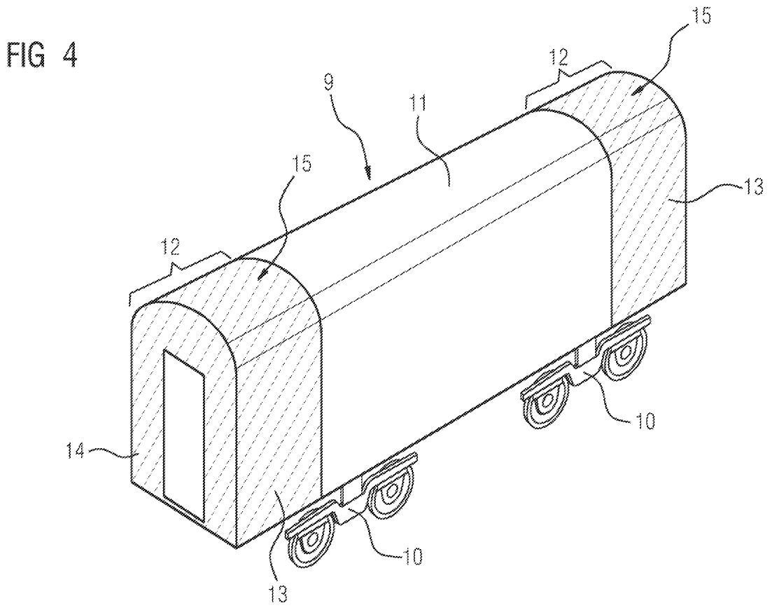

FIG. 4 shows a perspective view of a single car with end-side bogies which is equipped with hydrogen tanks, in a first embodiment,

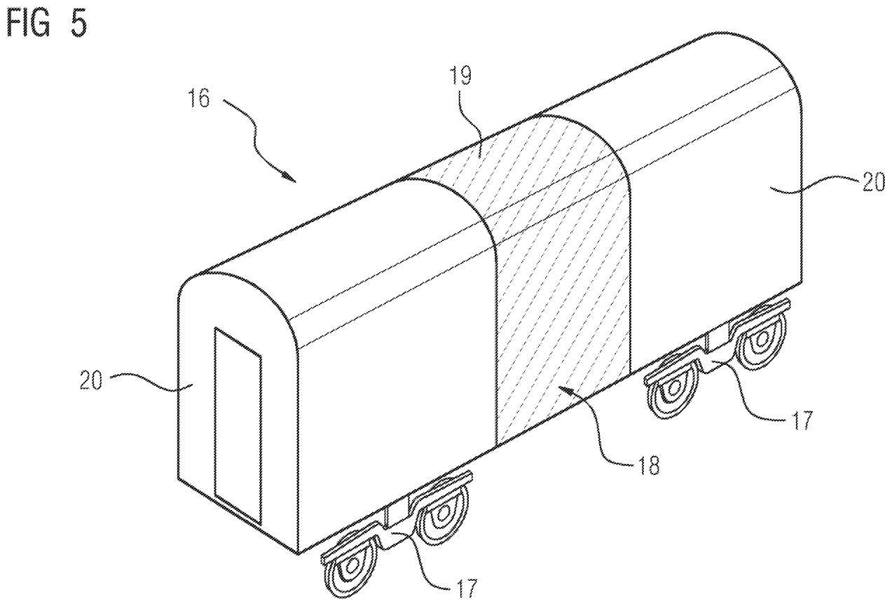

FIG. 5 shows a perspective view of a single car with end-side bogies which is equipped with hydrogen tanks, in a second embodiment, and

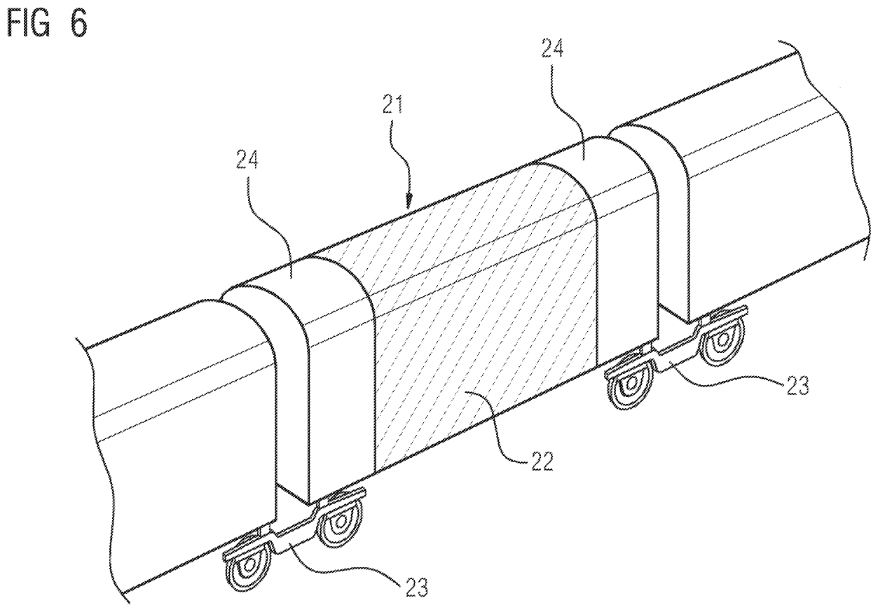

FIG. 6 shows a perspective view of a portion of an articulated train which comprises a rail vehicle car which is equipped with a hydrogen tank.

FIGS. 1 and 2 show two basic variants for integrating a hydrogen tank into the car body shell of a rail vehicle. Here, the hydrogen tank generally represents tanks which are suitable for storing gaseous fuels.

FIG. 1 and FIG. 2 each show a cross section through a longitudinal portion of the rail vehicle car which is used as a hydrogen tank.

In the case of the variant according to FIG. 1, the entire cross section of walls of the car body shell serves as hydrogen tank 1, that is to say the hydrogen tank 1 extends over a roof region 2, two side walls 3 and a floor 4 of the rail vehicle car. Taking all of these indicated wall regions of the rail vehicle car together, this results in a utilizable tank volume of great dimensions for storing hydrogen or hydrogen compounds. In the case of the variant which is shown in FIG. 1, it is possible for an interior construction of the rail vehicle car to be designed in the same way as outside the longitudinal portion which is shown, that is to say in longitudinal portions of the rail vehicle car which are produced in conventional manufacturing methods such as differential design (steel) and integral design (aluminum).

In comparison with this, a hydrogen tank 5 in the case of the variant according to FIG. 2 is distinguished by a substantially even greater storage volume than the hydrogen tank 1 according to FIG. 1. The relevant longitudinal portion of the rail vehicle car which is configured as a hydrogen tank 5 is present as an end wall or intermediate wall of the rail vehicle car, with the result that exclusively a passenger doorway 6 remains which allows passengers to be able to pass into that region of the rail vehicle car which lies in each case behind the hydrogen tank 5.

In the case of the embodiment which is shown in FIG. 3, a car transition module 7 is provided, the car body shell of which serves completely as a hydrogen tank. The car transition module 7 is arranged between two support cars 8 and is free of bogies. The transmission of longitudinal forces between the support cars 8 is performed via a coupling rod (not shown) which runs below the car transition module 7 and connects the two support cars 8 to one another directly.

FIG. 4 shows a single rail vehicle car 9 which is equipped with two bogies 10 which are situated in each case on the end side. A central longitudinal portion 11 of the rail vehicle car 9 is manufactured in the conventional design, for example from aluminum or steel. In addition, the bogies 10 are attached to the car body shell of the rail vehicle car 9 in the region of the longitudinal portion 11.

Respective overhangs 12 which adjoin the central longitudinal portion 11 and form the respective ends of the rail vehicle car 9 are configured as hydrogen tanks 13. Overhangs 12 of this type frequently cannot be fitted with seats on account of a provided reduced portion of the car body shell, and are therefore used for other fittings such as luggage racks, doors, etc. Therefore, the overhangs 12 can be configured as large-volume hydrogen tanks 13, associated end walls 14 corresponding to the variant explained in FIG. 2 for a hydrogen tank 5, while longitudinal portions 15 which adjoin the end walls 14 inward correspond in terms of their structure to the hydrogen tank 1.

FIG. 5 shows one variant of a rail vehicle car 16 which is once again equipped with end-side bogies 17. A central longitudinal portion 18 of the rail vehicle car shell is configured as a hydrogen tank 19. The hydrogen tank 19 is integrated into the car body shell, and adjoins end-side car body portions 20 which are manufactured in a conventional design. With regard to its load-bearing/static properties, the hydrogen tank 19 corresponds to those properties which a corresponding longitudinal portion of the car body would have if it had been manufactured in a conventional design, that is to say in the same design as the longitudinal portions 20.

FIG. 6 shows a part of an articulated train, one of the rail vehicle cars which are shown being configured in its central longitudinal portion 21 as a hydrogen tank 22. Here, the longitudinal extent of the centrally located hydrogen tank 22 is dimensioned in such a way that there is a sufficient longitudinal spacing from provided Jacobs bogies 23, with the result that the static loads of the hydrogen tank 22 are not too high. Both ends of the rail vehicle car 21 are adjoined by longitudinal portions 24, manufactured in a conventional design, of the rail vehicle car 21. Here, the load-bearing structure of the hydrogen tank 22 is designed in such a way that the same requirements are fulfilled as if the hydrogen tank 22 had been produced in the same design as the longitudinal portions 24.

A common feature of all the exemplary embodiments which are shown is that the respective hydrogen tank 1, 5, 13, 19, 22 is joined to adjoining shell portions of the relevant rail vehicle car, for example by way of welding in the case of shells in a differential or integral design. In the case of the configuration of the hydrogen tanks 1, 5, 13, 19, 22 in fiber reinforced plastic (GFRP, CFRP), structural adhesive bonding is used for joining to adjacent car body shell portions made from metal. A feed line (not shown in the drawing) is also provided in each case for a fuel cell.

1-8. (canceled)

9. A rail vehicle car, comprising:
a car body shell of the rail vehicle car; and
at least one tank for storing gaseous fuels, said at least one tank being integrated into said car body shell, and said at least one tank having walls constructed to assume a load-bearing function within said car body shell.

10. The rail vehicle car according to claim 9, wherein said car body shell has a longitudinal portion and walls with a cross section, and said longitudinal portion is formed at least predominantly by said at least one tank over an entirety of said cross section.

11. The rail vehicle car according to claim 10, wherein said car body shell has an end wall or an intermediate wall, and said longitudinal portion completely encloses said end wall or said intermediate wall.

12. The rail vehicle car according to claim 10, wherein:
said car body shell has bogie regions;
end-side bogies or a single bogie is disposed centrally in a longitudinal direction of the rail vehicle car; and
said longitudinal portion formed by said at least one tank includes an overhang lying outside said bogie regions.

13. The rail vehicle car according to claim 10, wherein:
said car body shell has bogie regions and a length;
the rail vehicle is equipped with end-side bogies or the rail vehicle is configured as an articulated train car; and
said longitudinal portion formed by said at least one tank is disposed centrally outside said bogie regions and over said length of said car body shell.

14. The rail vehicle car according to claim 9, wherein:
the rail vehicle car is configured as a bogie-less car transition module having ends and a coupling rod;
said coupling rod exclusively transmits longitudinal forces between car bodies adjoining said ends of said car transition module without involvement of said car body shell of said car transition module; and
said car body shell is configured at least predominantly as said at least one tank.

15. The rail vehicle car according to claim 9, wherein said at least one tank is formed of the same material as adjoining car body shell portions.

16. The rail vehicle car according to claim 9, wherein said at least one tank is formed of fiber-reinforced plastic and adjoining car body shell portions are formed of metal.
